(19) United States
(12) Patent Application Publication
(10) Pub. No.: US 2026/0257089 A1
(43) Pub. Date: Sep. 3, 2026

(54) Autonomous Intelligent System for Rapid Wildfire Detection, Eradication, and Prevention

(71) Applicant: Sheree H. Wen, Medina, WA (US)

(72) Inventor: Sheree H. Wen, Medina, WA (US)

(21) Appl. No.: 19/239,701

(22) Filed: Jun. 16, 2025

(51) Int. Cl. A62C 3/02; G05D 1/661; G05D 1/69; G05D 101/15; G05D 105/40; G05D 105/55; G05D 107/20; G05D 109/20; G05D 111/10; G05D 111/30; G05D 111/67; G08B 17/00; H02J 50/10

(52) U.S. Cl. CPC A62C 3/0228; A62C 3/0271; G05D 1/661; G05D 1/69; G08B 17/005; H02J 50/10; G05D 2101/15; G05D 2105/40; G05D 2105/55; G05D 2107/22; G05D 2109/20; G05D 2111/14; G05D 2111/32; G05D 2111/67

(57) ABSTRACT

The disclosed invention relates to a fully autonomous, multi-layered intelligent system for rapid detection, eradication, and prevention of wildfires. The system comprises a Satellite wildfire AI data acquisition module (ADAM) and AI/ML fusing Engine (AIMSFE), a distributed network of AI-enabled sensing modules (AISNM), fire extinguishing modules (FEM), autonomous drones, drone stations, Firefighting Command Control Center (FCCC), Central Server, and a Next-Generation Autonomous Intelligent Communication Network (NGAICN). These components are powered by renewable energy sources and communicate through satellite and terrestrial links. The system employs real-time environmental sensing through and near ground, image analysis, AI/ML fusion engines, and emergency communication triggers to detect wildfire precursors—such as ember dispersal, smoke plumes, and thermal anomalies—and respond instantaneously with autonomous suppression actions without the need of human intervention. The system operates in remote and forested areas with little or no infrastructure, providing dependable, self-sustained, scalable, and intelligent wildfire mitigation.

### BACKGROUND OF THE INVENTION

Wildfires in the United States result in the annual loss of approximately 7 to 10 million acres of forested land and cause billions of dollars in property damage. These fires frequently originate in remote, rural regions densely populated with dry, flammable vegetation, where access by ground-based personnel and emergency vehicles is severely limited or delayed. Wildfires may also ignite during nighttime hours or under adverse conditions, further complicating early detection and timely response. By the time first responders arrive at the scene, the fire may have significantly intensified, fueled by wind, topography, and widespread vegetation.

Additionally, wildfires that occur outside of immediate neighborhoods often go unnoticed until they have already grown large, posing a significant challenge for early public awareness and response.

There exists a critical need for an intelligent, autonomous system capable of rapidly detecting the onset of wildfires and activating immediate suppression mechanisms—without reliance on human Intervention. This need is especially urgent in areas that are inaccessible or hazardous to human responders.

Currently, the majority of wildfire-prone regions lack data connectivity, making it difficult to implement effective wildfire detection, eradication, and prevention operations. These challenges underscore the need for self-sustaining and intelligent communication, power and response infrastructure capable of operating independently in such environments.

The present invention addresses these problems by offering an integrated, multi-layered solution that fuses data from diverse sources and enables real-time, autonomous action in wildfire prevention and suppression.

### SUMMARY OF THE INVENTION

This invention provides a comprehensive solution to the challenges of wildfire detection, prevention, and eradication, particularly in remote, forested, and infrastructure-deficient areas. The present invention introduces an autonomous intelligent system for the instantaneous detection and rapid eradication of wildfires in their emerging or early stages without human Intervention but open to override.

The system collects and fuses diverse geospatial, historical and environmental data using multiple AI agents deployed across satellite and ground-based sensor infrastructures. These agents employ advanced deep learning and machine learning (ML) models to detect wildfire precursors and ignition events with high temporal and spatial precision.

Upon detecting a potential wildfire, the distributed AI/ML Sensor Network Module AISNM and FEM will instantaneously release the suppressing materials and also instruct the system automatically to deploy AI/ML enabled autonomous aerial vehicles (drones) from strategically positioned drone stations or command centers. These specially designed drones are capable of autonomously navigating beneath dense tree canopies and approaching within feet of ignition points to conduct close proximity investigations and initiate targeted eradication measures.

This invention also discloses novel methods for identifying, detecting, and eradicating key precursors of wildfires, aiming to prevent ignition, growth, and propagation rapidly upon detection.

This system also employs the Next-Generation Autonomous Communication Network (NGACN) which is designed explicitly for forested, rural, and infrastructure-deprived regions, employing satellite technologies that have historically hindered wildfire rescue efforts.

This invention is specifically engineered for deployment in forested, rural, and infrastructure-deficient regions. It ensures continuous, reliable operation of wildfire prevention and eradication efforts, even in areas lacking conventional power grids and communication networks.

This invention is specifically engineered for deployment in forested, rural, and infrastructure-deficient regions. It ensures continuous, reliable operation of wildfire prevention and eradication efforts, even in areas lacking conventional power grids and communication networks.

### FIELD OF THE INVENTION

The present invention relates to autonomous intelligent environmental monitoring and emergency response systems. It pertains to a self-sustaining, AI-driven communication and sensing network designed for the rapid detection, eradication, and prevention of wildfires, particularly in remote, forested, and infrastructure-deficient regions.

The invention includes AI-based satellite and terrestrial sensing modules that utilize machine learning and sensor fusion to analyze environmental data in real time. It performs on-site autonomous decision-making and initiates pre-planned suppression actions to eliminate emerging wildfires before escalation. The system also leverages AI to manage a geo-coordinated global risk map, identifying and updating fire-prone zones and orchestrating targeted eradication operations to ensure containment and prevent re-ignition.

Additionally, the invention introduces a Next-Generation Autonomous Intelligent Communication Network (NGAICN) that dynamically supports all stages of wildfire.

### BRIEF DESCRIPTION OF DRAWINGS

FIG. 1 The Full Autonomous Wildfire Prevention and Eradication System.

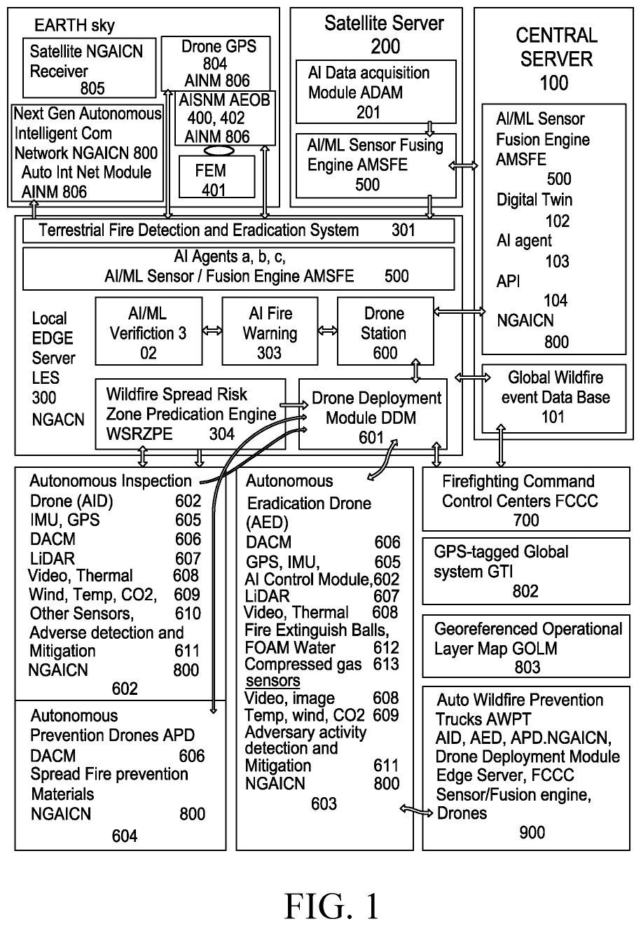

FIG. 2 satellite based AI data processing.

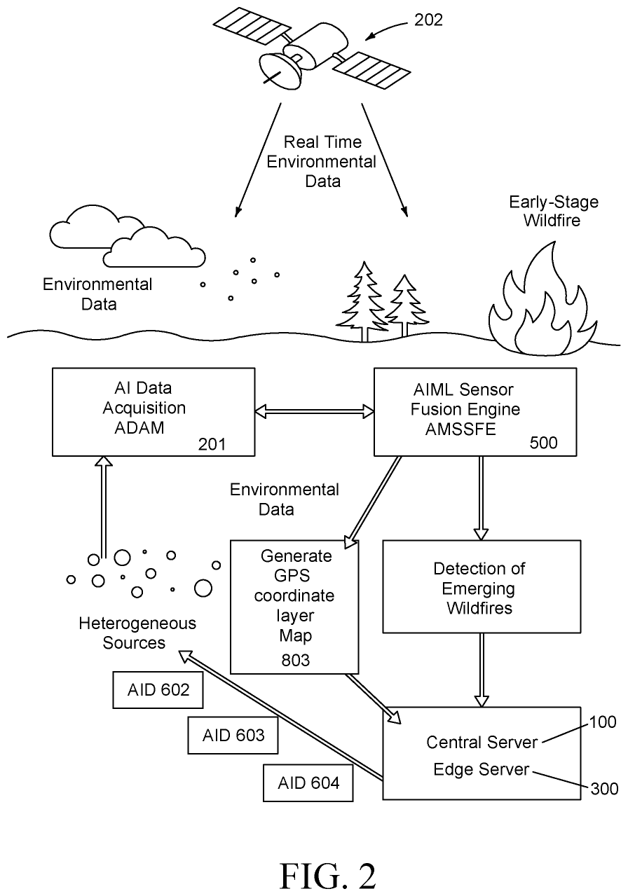

FIG. 3 An Autonomous intelligent System prevent Wildfire.

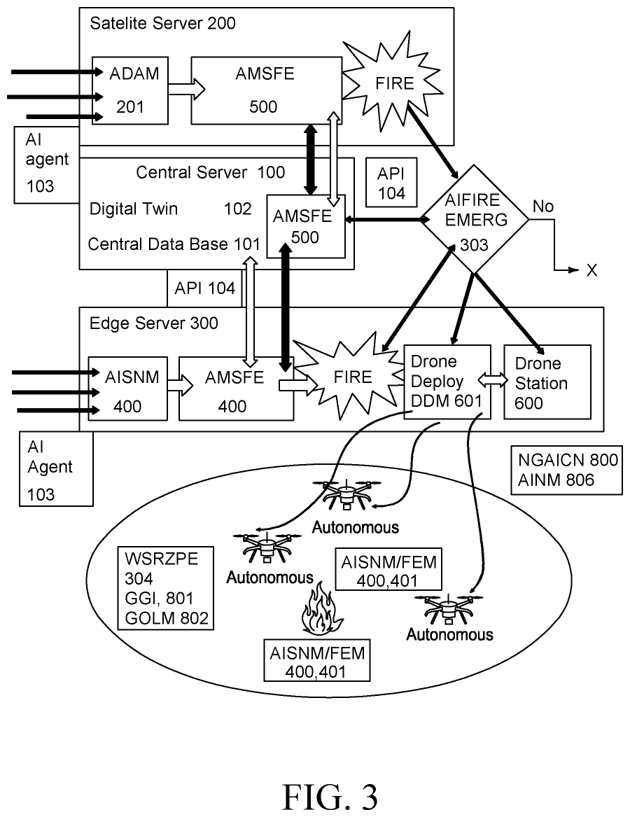

FIG. 4 AI Sensor Network Module (AISMN) and Fire Eradication Module (FEM).

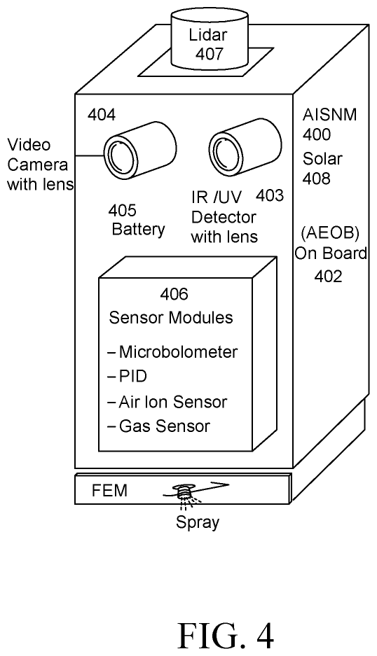

FIG. 5 illustrates the Autonomous Inspection Drone (AID).

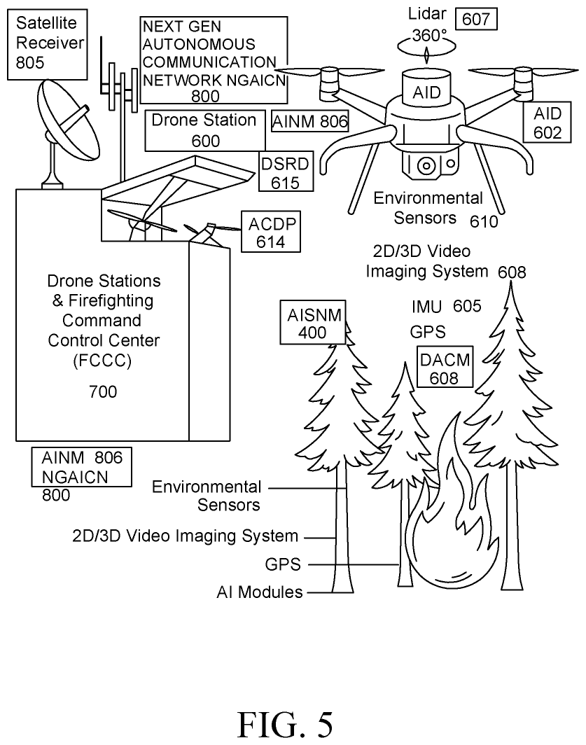

FIG. 6 shows the architecture and functionality of the Autonomous Eradication Drone (AED).

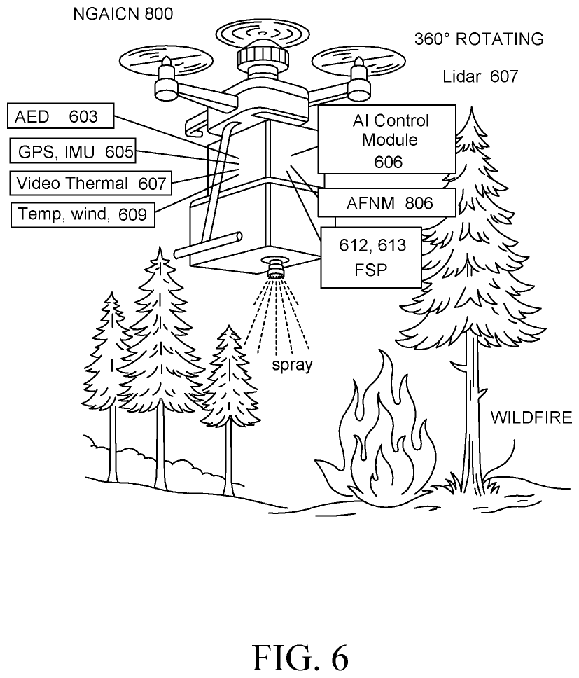

FIG. 7 Georeferenced Operational Layer map GOLM (802) generated by the AI/ML Wildfire Spread Risk Zone Prediction Engine (WSRZPE).

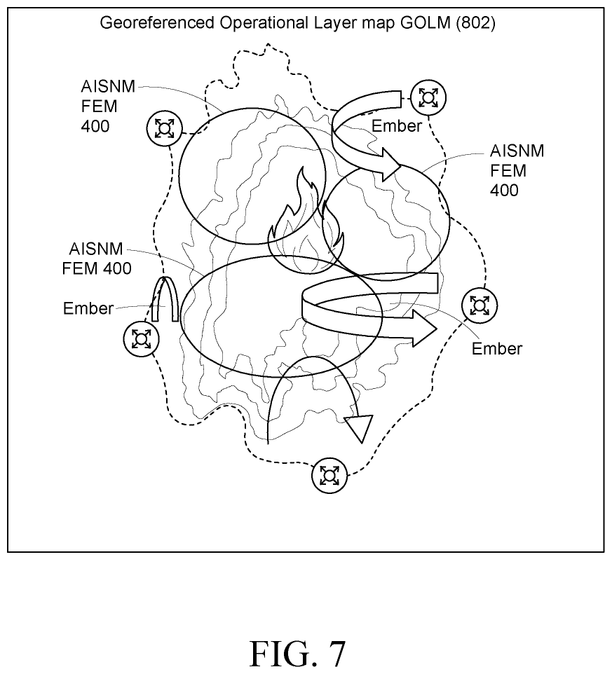

FIG. 8 Autonomous Ember Detection, Eradication and Wildfire Prevention.

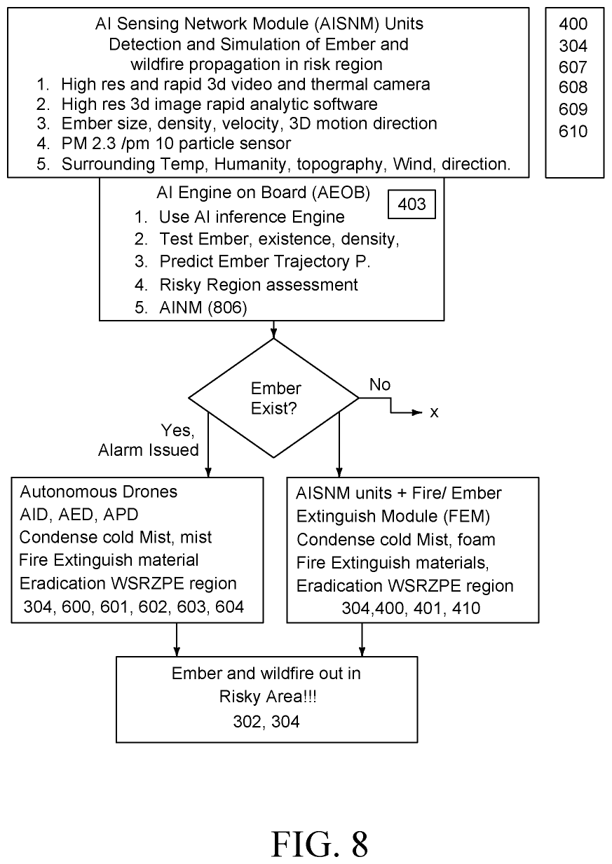

FIG. 9 A Next-Generation Autonomous Intelligent Communication Network (NGAICN).

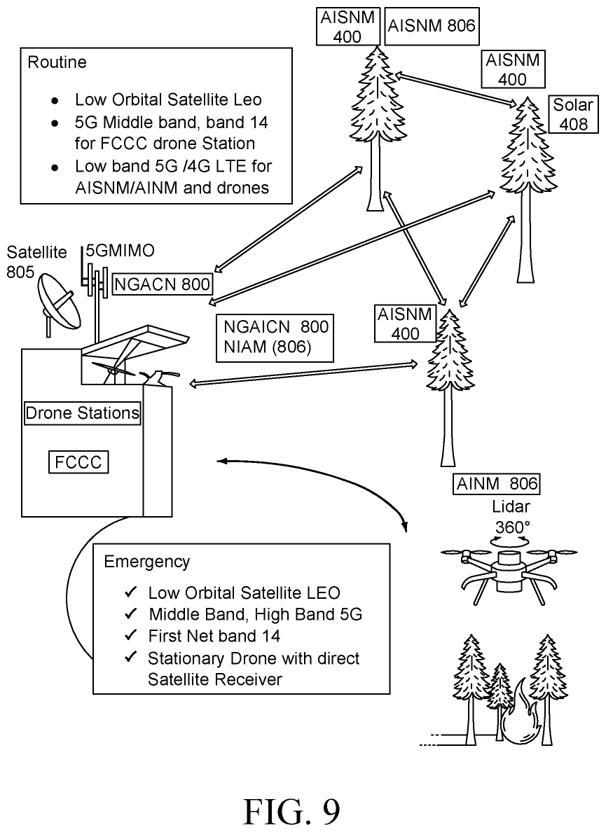

### DETAILED DESCRIPTION OF THE INVENTION

The present invention relates to an autonomous, intelligent multi-layered wildfire prevention and eradication system that integrates space-based data, terrestrial sensor networks, autonomous aerial systems, and artificial intelligence (AI) engines to detect, verify, and eliminate wildfire events during their incipient stages. The system is configured to prevent wildfires from igniting and escalating into uncontrollable spread by enabling full autonomous real-time monitoring, intelligent response coordination, and autonomous suppression mechanisms.

The system comprises Central Servers (100) (remote and/or local), Edge Servers (300) (primarily local), and Satellite Servers (200) (which may be located onboard satellites or co-located with Central or Edge Servers). These servers are connected through a distributed computing and communication architecture, allowing for synchronized data exchange and coordinated operations across all system layers.

Central Server (100) Monitor Distributed Wildfire Detection and Coordinating Global Response Operations.

The Central Server is configured to monitor a plurality of distributed wildfire detection nodes and coordinate global or regional wildfire response operations. The Central Server performs the following operations:
1. Hosts a global or regional Central Artificial Intelligence/Machine Learning (AI/ML) Sensor and Fusing Engine AMSFE (500), operatively coupled with a Global or Regional Wildfire event database (101) and a high-capacity storage subsystem for persistent data retention.
2. Maintains and updates a digital twin module (102) representative of global or regional wildfire-prone regions and archives historical wildfire event data, including ignition features, propagation patterns, and mitigation outcomes from worldwide incidents.
3. Manages incoming and outgoing data streams associated with the Central AMSFE, including ingestion pipelines for real-time and batch data, extraction of event-specific features, automated labeling of incoming datasets, and application of time-series analytics for detecting and characterizing critical events.
4. Upon confirmation of a wildfire ignition event, the Central Server is operable to issue immediate alerts via standardized Application Programming Interfaces APIs (104) and to deploy autonomous AI agents (103) to one or more designated Edge Servers (300) proximal to the ignition location, as well as to one or more Satellite Servers (200) for enhanced situational awareness and response coordination.
5. Publishes a structured wildfire event object based on GPS-tagged Infrastructure GTI (801) Global or Regional, including a standardized wildfire symbol, geospatial coordinates, and an estimated affected area, which is integrated into a globally or Regional accessible, geocoordinate-based wildfire map platform GOLM (802).
6. Upon receipt of the alert API, a local AMSFE located proximate to the reported ignition site is configured to automatically fuse the alert information with live telemetry from a terrestrial AI Sensing Module Network AISNM (400). If the ignition event is verified by the fused data stream, the system autonomously triggers localized warning protocols and initiates predefined eradication or containment procedures.
   A Satellite Server (200) detects, collects, and processes remote sensing data surrounding wildfires.
7. A satellite-based system comprising an Artificial Intelligence Data Acquisition Module ADAM (201) configured to remotely acquire Earth environmental data from a plurality of heterogeneous sources. The ADAM is operative through multi-agent AI architecture that coordinates data collection across diverse sensing modalities, including thermal, spectral, optical, ionospheric, and atmospheric observation platforms.
8. The satellite-based system further includes an AMSFE (500), which is configured to ingest a plurality of newly detected, live-streaming datasets generated by ADAM. The AMSFE fuses this real-time data with AI agents trained on historical wildfire events, enabling rapid identification and classification of ignition signatures associated with emerging and early-stage wildfires.
9. The AMSFE is further configured to perform cross-validation of the detected signatures using advanced computational and signal processing techniques, including but not limited to: time-based live stream deep learning models, quantitative analysis, least squares modeling (LSM), Dynamic Time Warping (DTW), Fourier transform analysis, changepoint detection, environmental trend modeling, and adaptive deep learning frameworks.
10. These techniques enable robust anomaly detection, pattern recognition, and dynamic adaptation to environmental changes, supporting real-time wildfire monitoring. The AMSFE supports the system's capacity to distinguish true ignition events from environmental anomalies with high precision.
   The Satellite Server (200) generates the following components:
11. Earth Base Layer: a foundational layer consisting of high-resolution satellite imagery of the Earth's surface and an operational layer containing GPS-tagged global infrastructure GTI (801). This layer incorporates critical geographic features such as highways, roads, forests, mountains, lakes, terrain, vegetation, and other topographic landmarks essential for wildfire propagation modeling and prevention.
12. Georeferenced operational layer containing GTI (801), including Drone Stations, Firefighting Command Control Centers FCCC (700), AISNM (400), Next Gen Autonomous Intelligent Communication Network NGAICN (800), and Auto Wildfire Prevention Trucks AWPT (900). These assets are mapped for the coordination of wildfire eradication actions.
13. Georeferenced Thermal Detection Layer-A detection layer that integrates thermal, infrared, and visible spectrum imaging to capture fire-related heat signatures spatially overlaid onto the Earth's base layer for geospatial analysis.
14. Georeferenced Combustion Indicator Layer—A layer identifying wildfire precursors, including smoke dispersal, elevated ion concentrations, and the spectral characteristics of ionized gases and thermally reactive chemical compounds within the vicinity of combustion.
15. Anomaly Event Detection via Time-Series Analysis—The system applies time-series analysis to detect anomaly events by identifying sudden changes—rises or drops—in sensor readings that may signify ignition events.
16. Satellite-Based Smoke Dispersal Detection-The system prioritizes smoke detection as a primary indicator of emerging wildfires, both before and immediately after ignition.
17. Electromagnetic Emission Monitoring—Captures electromagnetic signals associated with wildfire activity, including radio frequencies in the Very Low Frequency (VLF) and microwave bands.
18. Historical Data Repository—Maintains a global archive of historical datasets corresponding to the layers above.
19. All data is GPS-tagged to the Earth base layer and is critical for training AI/ML wildfire detection models.

### Satellite AI/ML Sensor Fusion Engine AMSFE (500)

20. The AMSFE fuses historical and real-time data across layers using GPS-tagged AI agent modules and APIs.
21. AMSFE generates wildfire alert data, including predicted ignition location, estimated ignition time, and estimated fire size, displayed across local, regional, national (U.S.), or global maps based on threshold exceedance.
22. Threshold-Based Alert Protocol—When the AMSFE detects conditions exceeding a predefined wildfire risk threshold, it activates an alert protocol.
23. AMSFE places graphical symbolization on the Earth base map.
24. AMSFE immediately transmit warning signals to a central or edge server nearest the suspected ignition site.

### Local Edge Servers LES (300)

25. Local Edge Servers are co-located within Drone Stations (600) and Firefighting Command and Control Centers (FCCC) (700). These servers are configured to receive and process data from multiple Terrestrial AI Sensing Module Networks AISNM (400), with each data stream represented by a dedicated AI agent.
26. Local edge servers ingest data from three primary sources: local Terrestrial (AISNM), Satellite Servers, and Central Server global databases.
27. From the Satellite and Central Server, Edge Servers access and validate georeferenced historical wildfire event data and GTI generated by Satellite and central server. The above datasets are an essential part of the Wildfire spread Risk Zone prediction Engine WSRZPE (304), enabling precise and rapid wildfire eradication deployment.
   Terrestrial AI Sensing Module Networks (AISNM) comprises.
28. an AI Engine on Board module AEOB (402) and
29. a suite of detection devices, which may include Lidar (407), 2D/3D high-resolution rapid video systems (404), thermal imaging (407,403), particle counters, spectrometers, electromagnetic wave sensors, miniature ion chromatography systems, ion-selective electrodes, spectrophotometry, colorimetry instruments, and other relevant sensors (406).
30. AISNM units stream live data related to wildfire indicators, including smoke dispersal, ember dispersal, elevated ion concentration levels, and the spectral characteristics of ionized gases and thermally reactive chemical compounds near the combustion zone. 103
31. The AEOB applies time-series analysis to label anomaly events, specifically identifying sudden increases or decreases in sensor measurements as potential wildfire ignition signatures.
32. AISNM data includes but is not limited to wildfire-related signatures such as temperature, humidity, 3D video imagery, and ultra-high-resolution AI image analysis of particulate density, velocity, 3D directional movement, material composition, and other key indicators of fire activity.
   Terrestrial AI/ML Sensor/Fusion Engine AMSFE (500) comprises:
33. Each AISNM live data stream is represented by an AI agent (103) and input into the AMSFE (500) in the local edge server.
34. These data streams, composed of both real-time sensor inputs and historical signature datasets, are ingested into the AMSFE through dedicated APIs (104).
35. The AMSFE engine employs supervised and unsupervised machine learning algorithms trained to identify wildfire precursors such as abrupt thermal spikes, dry fuel presence, converging wind vectors, ion concentration surges, anomalies in electromagnetic signatures, smoke, and ember patterns.
36. When the AMSFE output exceeds a predefined risk threshold, the engine issues an automated wildfire alert and initiates the dispatch of Autonomous Inspection Drones AID (602) for real-time site verification and situational assessment.
   Dispatch of Mission-Ready Autonomous Inspection Drone AID (602) comprises:
37. Upon detecting an anomalous event potentially indicative of wildfire ignition, the system automatically dispatches a mission-ready AID (602) from its resting pad, located within a dedicated Drone Station (600).
38. A comprehensive suite of advanced technologies, including Drone AI Control Modules DACM (606) for autonomous navigation, sensor data management, real-time analysis, and mission automation.
39. an Inertial Measurement Unit IMU (605) for stabilization and orientation, a GPS-assisted AI navigation system (605), Lidar (607) for 3D imaging and obstacle avoidance, 2D/3D video imaging systems (608), smoke and ember detectors and environmental sensing instruments (610).
40. An onboard DACM governs the Drone to the communication network NGAICN (800), autonomous flight, dynamically determining the optimal flight path to the suspected ignition site.
41. DACM monitors the onboard devices and sensors; the integrated Lidar and imaging systems enable the Drone to measure distances, avoid obstacles, and inspect obscured areas beneath forest canopies.
42. Lidar allows AID accurately to identify the fire's point of origin and maintain proximity within a few feet of the emerging ignition.
43. Once the ignition site is confirmed, the AID transmits its precise geocoordinates along with corresponding visual and sensor data to the AMSFE on the edge server at the associated drone station or Firefighting Command Control Center (FCCC).

### Autonomous Response and Deployment of Autonomous Eradication Drones AED (603)

44. Upon confirmation of high-probability detection of a wildfire ignition event, the system automatically dispatches one or more Autonomous Eradication Drones AED (203) from the nearest drone station.
45. Each AED is equipped with specialized Fire Suppression Payloads FSP (612, 613) capable of delivering targeted extinguishing agents, such as water, compressed nitrogen, and other firefighting materials.
46. The drones are also equipped with real-time visual and thermal imaging systems (607, 608) and
47. are engineered to operate effectively in adverse conditions, including low visibility and nighttime environments.
48. Each AED is controlled by a DACM onboard, which integrates data from GPS, IMU, Lidar, and video and thermal imaging systems.
49. The DACM module enables fully autonomous navigation and dynamically adjusts flight paths and payload deployment strategies in response to real-time environmental data and evolving mission parameters.

### Autonomous Fire Eradication Coordination and Reporting

50. The Autonomous Eradication Drones (AED) navigate to the ignition site using GPS and their onboard autonomous AI navigation systems.
51. Upon arrival, the AEDs execute suppression protocols.
52. transmitting high-resolution imagery, thermal sensor data, and telemetry to the edge server and at FCCC (700).
53. All mission-related data and digital twins are logged in real-time for post-incident analysis and are subsequently used to retrain and optimize the AI models for future wildfire response operations.

### Post-Wildfire AI/ML Verification and Prevention

54. Following fire suppression, AIDs are redeployed to the ignition site to confirm that the fire has been fully extinguished.
55. AID conducts proximity inspections to identify residual heat signatures or signs of smoldering.
56. The AIDs transmit real-time verification data to the local edge server,
57. The AI/ML Verification Module (302) evaluates site conditions. If potential reignition risks or latent combustion sources are not detected, the system automatically deploys Autonomous Prevention Drones APD (604).

### Preventive Fire-Retardant Deployment by Autonomous Prevention Drones APD (604)

58. APD equipped with fire-retardant dispersal systems and deployed to the perimeter and surrounding areas of the extinguished fire zone. Their primary function is to prevent the risk of fire rekindling and mitigate potential new ignition sources by applying retardant to high-risk zones.
59. Operating in fully autonomous mode, APDs utilize onboard DACM, GPS navigation, and environmental sensors to analyze terrain characteristics, vegetation density, and localized fire risk factors. This data enables the system to dynamically optimize dispersal routes and coverage patterns and input them into the AI/ML Wildfire Spread Risk Zone Prediction Engine (WSRZPE) to generate updated maps for future wildfire references. Ensure the efficient and targeted application of fire retardants for maximum preventive impact.

### Multi-Parameter Verification Protocol

60. Following the detection of a potential wildfire ignition, the system initiates a multi-parameter verification protocol designed to validate the anomaly through a series of cross-checks and analytical procedures.

### Cross-Correlation Analysis:

61. The system conducts cross-correlation of the detected anomaly against data received from geographically proximate terrestrial sensors, satellite sensors, and drone-based instruments.
62. This process verifies signal consistency across multiple independent sources. Simultaneously, temporal change detection is performed using satellite imagery to identify physical alterations in the target area, such as emerging heat signatures, smoke plumes, or changes in landscape reflectivity.

### Multimodule Sensor Fusion and Analysis:

63. Combustion particles' concentration data is analyzed in synchronization with other sensor modalities, including thermal imaging, visual video streams, and gas composition readings.
64. These data streams are ingested and processed by the AI/ML detection engine to improve the identification of early-stage combustion events. This fusion-based analytical approach enhances detection accuracy and significantly reduces the occurrence of false positives.

### Drone Stations and Firefighting Command Control Center (FCCC)

65. Drone stations sometimes co-locate with FCCC to enhance operational coordination and deployment efficiency.
66. FCCCs and their associated drone station facilities are strategically located near highways or major road intersections surrounding wildfire-prone areas. These locations are chosen to ensure optimal accessibility for firefighting personnel, emergency vehicles, water tankers, and supply units.
67. Each Drone is deployed by the Drone Deployment Module DDM (601). DDM assigns each Drone to a designated, barcoded AI-Controlled Drone Pad ACDP (614). These pads support automated charging, payload loading, and pre-flight readiness testing to ensure rapid, autonomous deployment when needed.
68. Upon receiving a mission command, DDM auto activates and opens the drone station's roof or doors DSRD (615), enabling the autonomous launch of one or more drones toward the designated fire site.
69. After completing their missions—or when low on power or resources—drones autonomously return to their assigned pads using DACM. Once docked, the drones are automatically recharged, resupplied, and made ready for subsequent missions.
70. The FCCC is equipped with advanced operational infrastructure, including edge servers, mission control dashboards, real-time video displays, graphical user interfaces, sensor network controllers, drone station control panels, dispatch modules, and coordination tools to assist firefighting teams and emergency responders.
71. The FCCC houses Edge and/or Central servers, the AI/ML Sensor Fusion Engine, and the Next Gen Autonomous Intelligence Communication Network NGAICN (800), serving as the command hub for data integration and operational decision-making.
72. While the system is designed to operate as a fully autonomous, rapid-response, closed-loop process without human involvement, human intervention capabilities are available at every stage of operation, allowing manual control or override when necessary.

### Wildfire Prevention Through Detection and Instantaneous Eradication of Precursors: Ember and Smoke

Wildfires often originate and propagate through two critical yet frequently overlooked precursors: Ember and Smoke dispersal and propagation. These phenomena can occur before visible flames are detected, making them essential targets for early intervention.

We disclose a novel multi-layered approach for early wildfire prevention that focuses, specifically on these precursors. This system introduces dual-path detection and suppression architecture, integrating real-time data from environmental sensors, AI/ML models trained on topography, weather and wind, vegetation dry/wet conditions, and autonomous aerial response units. Together, these layers enable preemptive actions before ignition or fire growth, transitioning wildfire response from reactive containment to proactive prevention.

Ember and smoke are among the earliest detectable indicators of wildfire emergence, often preceding visible ignition, or flame.

Embers serve as the primary agents of ignition and can travel long distances—sometimes several miles—under wind influence, igniting new fires far from the original source. Consequently, it is critically important to detect, track, and eliminate embers immediately at both the ignition site and the downwind perimeter to prevent the development and large-scale spread of wildfires.
73. The AISNM/FEM (400,401) modules are strategically placed throughout the wildfire-prone region and are designed to suppress embers on site instantly.
74. Each AISNM module comprises an AI Engine on Board (AEOB) (402) and multiple environmental mini sensors that are overly sensitive to detect precursors and combustion products after ignition, including embers, smoke, and combustion products.
75. The AEOB, with sensor inputs, detects embers and smoke based on one or more features, including particle density, heat signature, ion concentration, gas composition, movement velocity, and 3D directional vectors.
76. A Fire/Ember Extinguishing Module FEM (401) attached to AISNM is configured to instantly activate immediately upon detection of an ember; an alarm will issue and send a signal to the Edge Server.
77. Simultaneously all AISNM/FEM modules are activated within the Wildfire spread risky Zone generated by WSRZPE.
78. WSRZPE uses time-based AI inference from high-speed thermal and video imagery to predict Ember spread patterns. The WSRZPE generates a Georeferenced Operational Layer map GOLM (802) and marks the potential spread zone surrounding the fire ignition site when the fire starts.
79. The Edge Server overlays real-time threat data on the GOLM, including the locations of roads, lakes, drone stations, FCCC, and existing AISNM deployments on the GOLM.
80. The Edge server’ drone deployment module will launch an autonomous drone fleet instantly that includes AI Investigation Drones (AID), AI Eradication Drones (AED), and APD to clean the entire WSRZPE risk zone to prevent fire propagation.
81. Each AED drone, equipped with payloads of fire extinguishing materials, is launched and autonomously navigated to the designated fire site and high-risk regions by the WSRZPE.
82. After the fire is eradicated, AID is relaunched to investigate and ensure that no ember, no flame, and no smoke remain; the system will then announce that the fire is out.
83. APD will be Launched to spread fire retardant materials to prevent fire rekindling in identified risk zones operating in fully autonomous mode.
84. The autonomous drones are programmed to return to their AI-controlled Drone Pad ACDP (614) at drone stations after the mission is accomplished for automatic recharging and payload replenishment.
85. After the mission is accomplished, newly prepared AISNM modules with full FEM payloads are carried and deployed autonomously by the drones to the sensor site, where they reside.
86. The detection and suppression actions from initial precursor identification to extinguishing action can be completed autonomously and rapidly without human intervention.
87. The AEOB AI Communication Module coordinates all data flows between AISNM units, drones, and edge servers.
88. The AWSRZPE determines spread risk zones by simulating ember travel under real-time environmental conditions, including wind direction, slope inclination, and vegetation dryness.
89. Complete eradication of ember and smoke dispersal is confirmed via feedback from deployed drones and AISNM image analysis before issuing a wildfire-out declaration.

### The Physical Unit of the AISM Module

90. The AISNM module consists of several critical sensors, including MEMS thermal sensors (such as microbolometers or thermopiles), photoionization detectors (PID), electrochemical gas sensors, air ion counters, and Gas sensors (406). The UV/IR detector (403) detects a small flame without a false positive.
91. These sensors are capable of detecting particles, ionized species, UV and IR radiation, as well as thermal and flame signatures,
92. Above sensors are essential for identifying wildfire precursors, ignition points, and early-stage combustion.
93. All sensors are miniaturized, highly sensitive, and optimized for detecting ember, flame, and combustion products.
94. Each AISNM unit comprises multiple detection systems, including LiDAR and 2D/3D high-resolution rapid video and thermal imaging components.
95. These systems are designed to capture time-based thermal and video data, allowing AI-based analysis of ember and smoke image.
96. characteristics, including density, size, signature, velocity, and directional movement, particularly before landing and causing ignition.
97. Upon positive identification of ember and smoke presence, the onboard AI Engine (AEOB) validates the occurrence of an emerging wildfire. It immediately issues an alert while initiating suppression protocols by notifying surrounding AISNM units and the edge server.
98. Once the Wildfire is confirmed to be eradicated, the AEOB sends a termination signal—an “end-of-fire” message—to adjacent AISNM units and the edge server, halting active operations and returning to monitoring mode.
   AISNM Module Construction comprises:
99. The construction of the AISNM Unit includes mini versions of AEOB, sensitive miniature sensors, and communication modules, as well as memory modules to store several days of video and sensor data,
100. All sensors and devices are enclosed in a shoebox or smaller sized enclosure for easy mounting and field service.
101. The AISNM unit is engineered for self-sustained deployment in wildfire-prone, forested, and rural environments.
102. AISNM module possesses essential physical properties, including heat and flame resistance, UV and weather protection, electromagnetic shielding, lightweight construction, and field durability.
103. The compact form factor of the AISNM unit supports flexible deployment options, including tree-mounting, drone attachment, and installation on utility poles.
104. Each AISNM unit contains an integrated microcontroller, power conditioning system, energy, memory, and sensor ports to support modular expandability and real-time data acquisition.
105. Power to the AISNM is supplied by a self-sustaining system consisting of a solar panel (408), a battery pack (405), and a maximum power point tracking (MPPT) controller, allowing for off-grid, self-sustained operation over extended periods.
106. The AISNM can detect the image, density, size, signature, velocity, and movement directions of embers and smoke before they land and cause fire ignition.
107. Once the presence of embers and smoke is positively identified, the AEOB rapidly confirms the existence of an emerging fire, immediately issues an alarm, and initiates eradication actions to other AISNM and Edge servers.
108. Once Wildfire is eradicated, the AEOB issues an “End of fire” message to other AISNM and edge servers.

### AI/ML Wildfire Spread Risk Zone Prediction Engine (WSRZPE)

109. The WSRZPE is a core AI/ML module deployed on Central and/or Edge Servers within the multi-layered wildfire prevention architecture. It is designed to identify and predict high-risk wildfire propagation zones by analyzing real-time and historical data, with a focus on ember dispersal as the primary ignition vector.
109. Ember Dispersal as a Primary Spread Mechanism: Ember dispersal represents a critical factor in wildfire spread dynamics.
110. Embers, particularly under high wind conditions, can travel several miles from the original site, landing on flammable surfaces and causing secondary ignitions across vast territories.
111. Early identification and modeling of ember movement are essential for anticipating fire spread beyond the immediately visible perimeter.
112. High-Speed, High-Resolution AI Imaging Inputs: The system ingests ultra-high-resolution and high-speed thermal and optical video imaging data from deployed sensing units, including terrestrial AISNM and drone-based systems. Using time-based AI analytics, the system extracts and quantifies key parameters of embers in motion, including particle size distribution, Ember density and concentration, Velocity and acceleration, and 3D vectorized directional movement over time. These image-derived features serve as foundational inputs to the WSRZPE.
113. Georeferenced Risk Zone Mapping: Using a geo-anchored Earth base map, the WSRZPE overlays ember movement data and generates predictive risk zone heatmaps.
114. These maps identify areas most vulnerable to fire propagation based on ember trajectory and velocity vectors, considering spatial proximity to combustible vegetation, infrastructure, and terrain characteristics.
115. Multi-Factor Predictive Modeling: The WSRZPE integrates a range of pre-trained AI/ML models trained on environmental and topographical datasets, including: Elevation profiles (mountains, valleys, hills, slopes), Vegetation type and dryness levels, Presence of lakes, rivers, or firebreaks, Real-time and historical weather data (temperature, humidity, wind speed and direction. Seasonal variations and prior fire events in the area.
116. These variables are fused using a sensor fusion engine and advanced AI techniques (e.g., trend detection, changepoint analysis, temporal-spatial modeling) to simulate potential ember routes and predict future spread zones.

### Integration With Response Assets and Eradication Systems:

117. The WSRZPE is integrated with pre-stored GPS-based geolocations of critical wildfire prevention and response assets, including Autonomous Drone Stations, FCCC, AISNM, NGAICN, and AWPRT truck.
118. Upon detection of a high-risk region, the WSRZPE automatically initiates coordinated emergency operations. These include the dispatch of drones for targeted ember or flame suppression, activation of ground-based suppressant systems, and notification to FCCCs for broader containment actions.
119. Closed-Loop Operational Intelligence

The WSRZPE is designed to operate in fully autonomous mode, it also allows human override but prioritize rapid, machine-driven responses.

Risk zone predictions are continuously refined in real time based on live sensor inputs and feedback from deployed drones and sensors. The result is a dynamic and constantly updating operational map of wildfire risk, capable of preempting large-scale fire outbreaks through predictive analytics and proactive intervention.

Next Gen Autonomous Intelligent Communication Network NGAICN (800) for Wildfire prevention and eradication.

For decades, wildfires have destroyed millions of acres of forest per year in the United States and continue. One of the significant challenges is the extreme difficulty in building telecommunication infrastructure in that area, and the fire propagates very quickly before humans can reach it.

Under this constraint, this invention discloses unique solutions that address these issues.

This invention discloses a novel, self-sustaining, and modular communication and power architecture that can operate in areas where connections were previously impossible.

Additionally, the disclosed system is optimized for both routine environmental monitoring and emergency wildfire eradication, particularly in rural, forested, mountainous, or undeveloped areas.

### System Architecture and Components

120. This NGAICN is a novel, self-sustaining, and modular communication and power architecture that can operate in areas where connections were previously impossible.
121. NGAICN is intelligently optimized for low-cost, routine environmental monitoring and can be autonomously and instantly transformed into 5G, high-speed, high-bandwidth technology for emergency wildfire eradication, particularly in rural, forested, mountainous, or undeveloped areas.
122. NGAICN uniquely overcomes the challenges of a lack of communication infrastructure in rural and forest areas by linking through Satellite.
123. NGAICN offers a solution to overcome the limitation that most satellites have limited data transmission capabilities and a data rate of only 2-3 digits, which is insufficient for wildfire monitoring and eradication operations.
124. NAGICA has overcome the challenge that most satellites require large satellite antenna receivers.
125. NGAICN offers a low-cost solution that utilizes Low-Earth Orbit (LEO) satellite signals as a communication backhaul, transforming them into 5G, LTE, Band 14, low-band, and IoT networks. These networks are then deployed in targeted rural areas to detect, eradicate, and prevent the spread and growth of wildfires.
126. The NGAICN equips FCCC and drone stations with a low-earth orbit (LEO) Satellite Antenna (805), providing high-reliability internet backhaul and transforming it into both high speeds and middle or high-band 5G quality services for wide-band server and facility connections, as well as low-band AISNM and drone connections for routine operations.
127. The NGAICN low-band 4G/5G LTE connection enables larger area wireless coverage across a 15-30-mile radius.
128. The NGAICN low-band 5G LTE supports drones and AISNM networks, meeting the tree-penetrating requirement.
129. The NGAICN provides an adequate data rate to nearby servers and systems through cost-effective connectivity and good area coverage, thereby reducing the number of satellite receivers required.
130. The NGAICN utilizes a Leo Satellite link as backhaul, with the distributed satellite receiver operatively coupled to an Autonomous Intelligent Network Module (AINM) (806), configured to receive satellite signals through a satellite dish or small devices in rural or historically connection-deprived areas.
131. The AINM module is designed with intelligent multiband components and software-defined Radios to autonomously transform the satellite band into commonly used transmission formats, including 5G, 4G LTE, radio, and more, according to environmental factors, system preset conditions, or user preferences.
132. AINM can serve as a sub-communication module within AISNM to manage communication operations.
133. NGAICN provides end users with routine data communication, internet access, voice, facility, device monitoring, or other usage, including IoT.
134. Each intelligent AINM node service has the capability to cover hundreds or thousands of users or device nodes within a 15-30-mile area,
135. Each AINM module is equipped with a small satellite dish and device, enabling it to upload and download data packages to and input from other users on the same or different networks.
136. AGNICN's communication policy excludes the use of high-orbit satellite systems and conventional Internet of Things (IoT) technologies, such as LoRaWAN and basic radio systems, due to insufficient bandwidth, data rate limitations, and a lack of compatibility with 5G and FirstNet emergency protocols.

The NGAICN features distributed multilayered dynamic node management.
(a) Layer 1: user or intelligent modules.
(b) Layer 2: Multiband intelligent communication AINM module layer.
(c) Layer 3: The regional node layer comprises the network of AINMs in the region.
(d) Layer 4: The super node layer comprises all the regional nodes in a country.
(e) Layer 5: Comprise all the nodes in the enterprise.
137. AI-driven emergency upgrade: Upon detection of an ember, smoke, or thermal anomaly, the AEOB (AI Engine Onboard) will instantly transition from Text data to active high-performance mode, engaging FirstNet or equivalent high-speed channels immediately. This instant switching protocol enables live video, AI analysis, and command coordination.
138. Some of the AISNM modules, which comprise AINM and compact satellite receivers (1×1), are deployed as second-layer nodes to transform Satellite signals into localized 5G signals, collectively extending NGAICN coverage to hundreds or thousands of miles or hundreds of thousands of customers.
139. Low-Cost and Efficient: Operating costs are minimal. Text-only transmission fees are extremely low; emergency mode is used only during critical events, typically lasting less than an hour; the system operates fully autonomously with minimal human oversight.

### Renewable Power Integration RPI (806)

140. Like communication, rural areas often lack power infrastructure.
141. Renewable Power Integration: All units are powered by solar or wind systems, with MPPT charge controllers ensuring over 95% efficiency.
142. Power Tier Optimization: Drone stations, FCCC buildings, and systems require higher-capacity solar systems, whereas AISNM modules operate on smaller, decentralized energy units with portable, small solar power cells.
143. Redundancy and Failover Systems: If fixed systems are damaged, rescue trucks and airborne drones equipped with satellite dishes serve as mobile replacements for FCCC nodes or AISNM hubs.
144. Wireless Drone Charging: in low-sunlight regions, drones can wirelessly charge AISNM units using electromagnetic induction, with or without physical contact.

### Mobile and Aerial Communication Nodes

145. Stationary Drones as communication nodes: During disasters, stationary drones equipped with satellite receivers function as NGAICN nodes. These drones broadcast localized 5G/6G, FirstNet, IoT, and victim rescue signals, supporting field coordination, drone fleet control, and emergency communications.
146. Rescue Truck as Mobile FCCC: The Rescue Truck functions as a mobile version of the FCCC, fully equipped with Satellite, cellular, and edge computing modules. It manages drone deployments. Acts as an autonomous communication node, supports real-time data processing and local decision-making, and can be relocated rapidly to support response efforts.

### CONCLUSION

This Next Gen Autonomous Intelligent Communication Network NGAICN and Power enables full-cycle wildfire prevention and eradication, from early precursor detection to autonomous suppression. By combining satellite internet, localized 5G, AI-driven protocols, and renewable energy sources, the system offers an unprecedented level of autonomy, responsiveness, and reliability for remote, wildfire-prone environments. The Next Gen Autonomous Intelligent Communication Network NGAICN and RPI represent a transformative leap from traditional, reactive firefighting to an initiative-taking, intelligent, and resilient wildfire defense ecosystem.

This high-efficiency solution for wildfire prevention, early detection, and autonomous suppression addresses critical gaps in rural communication and energy infrastructure by leveraging space-based connectivity, renewable energy, and AI-integrated edge systems with low cost.

This design transforms wildfire response from a delayed, reactive process into an autonomous, predictive, and location-adaptive defense grid.

What is claimed is:

1. An Autonomous Intelligent System for Rapid Wildfire Detection, Eradication, and Prevention Comprising:
(a) a multi-layered intelligent system for autonomous detection, eradication, and prevention of wildfires at the early stage, comprising:
(b) A combination of Central Server, Edge Servers (located in proximity to potential fire sites), and Satellite-based Servers (positioned on satellites or co-located with the Central Server);
(c) The Central Server is configured to monitor distributed wildfire detection and coordinate global response operations comprising:
(i) An Artificial Intelligence and Machine Learning Sensing and Fusion Engine (AMSFE);
(ii) A global wildfire event database including digital twins, Global historical wildfire events database and ignition signature features;
(iii) A module for generating alerts based on ignition detection via an Application Programming Interface (API);
(d) Satellite-based System comprising:
(i) AI Data Acquisition Module (ADAM) configured to acquire environmental data from a plurality of near earth heterogeneous sources surrounding ignition sites;
(ii) A Satellite-based AI/ML Sensor Fusion Engine (AMSFE) configured to fuse real-time and historical data to detect potential wildfire indicators;
(e) One or more Terrestrial Edge Servers comprising:
(i) A local AI/ML Sensor Fusion Engine (AMSFE) configured to receive and analyze real-time data streams from AI/ML Sensor Module Network AMSMN, and to fuse this data with historical wildfire features to determine the ignition's location, time, and signature characteristics;
(ii) An AI-based Warning Module configured to receive verified wildfire event data from the AMSFE and automatically issue alerts and activate emergency response actions;
(iii) A drone deployment unit comprising autonomous drone fleets, including Autonomous Inspection Drones (AID), Autonomous Eradication Drones (AED), and Autonomous Prevention Drones (APD), each drone configured for autonomous dispatch upon wildfire detection, and equipped with onboard AI modules for navigation and mission execution;
(f) One or more Drone Stations are integrated with a Firefighting Command and Control Center (FCCC), wherein drones are automatically recharged, resupplied, and launched in response to a mission initiation command.
(g) A Next-Generation Autonomous Communication Network (NGACN) configured to:
(i) interlink one or more communication channels, including satellite, terrestrial, radio, FirstNet, and Internet of Things (IoT) networks;
(ii) The NGACN is integrated with drone station buildings, stationary and aerial drones, AISNM network and mobile Autonomous Wildfire Prevention and Eradication Trucks (AWPETs) to support both routine operations and emergency wildfire response;
(jii) The system is further configured to automatically activate and switch to Emergency mode upon receiving an alarm signal, enabling high-priority communication channels, frequencies, services, and connected devices to ensure uninterrupted and responsive operation;
(h) A Fire Verification Module is configured to:
(i) confirm the presence of an active fire and to instantly issue an alarm upon detection of fire precursors or ignition.
(ii) The Fire Verification Module is further configured to issue a fire-out signal only after verifying that the fire has been completely extinguished;
(i) Intelligent autonomous Detection and Eradication Process comprising:
The Sensor input modules; Artificial Intelligence Data Acquisition Module (ADAM) from the Satellite and Terrestrial AI Sensor Network Module (AISNM) are configured to acquire environmental data from a plurality of heterogeneous sources surrounding a wildfire zone on Earth;
(i) an AI/ML Sensor Fusion Engine (AMSFE) configured to:
(A) analyze the environmental and Sensor data stream in real-time against past event features; and
(B) generates risk alerts based on learned new wildfire signatures that validate the fire existence;
(C) Once AMSFE announces Fire is emerging or in existence AI Fire Warning Module and the emergency procedures are instantly initiated on all fronts including:
(D) The NGAICN network autonomously jumps to middle and High band 5G and First Net modes to facilitate the emergency eradication process;
(E) AI warning Modules instantly sent emergency API to start AI autonomous emergency processes comprising: Drone Deployment Module DDM, Drone Station, AID, AED, APD, NGAICN drones, AISNM, FEM, WSRZPE, FCCC, FTGS, WSRZPE, GTGS, GOLM, and More;
(F) After drones and FEM cleared the Fire and ember, Fire Prevention Drones GPD would spread the fire prevention materials to prevent the rekindling of Fire;

2. Wherein claim 1, Comprising a Satellite-Based System Server configured to detect, collect, and process remote sensing data for wildfire monitoring, further comprising:
(j) an Artificial Intelligence Data Acquisition Module (ADAM) configured to acquire Earth observation data from multiple heterogeneous sources;
(k) the ADAM operating through a multi-agent AI architecture that coordinates data acquisition across thermal, spectral, optical, ionospheric, and atmospheric sensing modalities;
(l) an AI/ML Sensor Fusion Engine (AMSFE) configured to ingest and process real-time datasets acquired by ADAM; and
(m) a satellite server configured to generate:
(i) an Earth Base Layer comprising high-resolution satellite imagery and GPS-tagged Global Infrastructure (GTI);
(ii) GTI features including Drone Stations, Firefighting Command and Control Centers (FCCC), AISNM nodes, NGAICN modules, and autonomous wildfire prevention trucks (AWPT);
(iii) a Georeferenced Thermal Detection Layer integrating thermal, infrared, and visual-spectrum imaging;
(iv) a Georeferenced Combustion Indicator Layer identifying precursors including smoke, elevated ion concentrations, and chemically active spectral compounds;
(v) an Anomaly Detection Layer using time-series analysis to identify ignition-related sensor changes;
(vi) a Satellite-Based Smoke Dispersal Detection layer emphasizing smoke as an ignition indicator;
(vii) an Electromagnetic Emission Monitoring system configured to detect wildfire-related VLF and microwave signals;
(viii) a Historical Data Repository comprising labeled datasets used to train wildfire detection models; and
(ix) a Fusion Layer configured to generate wildfire alerts by combining historical and real-time GPS-tagged data using algorithmic fusion and AI agent modules.

3. Wherein claim 1, comprising A Satellite-Based AI/ML Sensor Fusion Engine (AMSFE) configured for high-precision wildfire detection, comprising:
(n) a processing framework configured to distinguish wildfire ignition events from environmental anomalies;
(o) modules configured to apply signal labeling, signal conditioning, feature extraction, correlation analysis, nearest-neighbor modeling, least squares modeling, Dynamic Time Warping (DTW), Fourier analysis, changepoint detection, and trend modeling;
(p) adaptive deep learning modules trained on historical wildfire ignition events;
(q) computational routines configured for cross-validation of detected ignition signatures;
(r) a wildfire response API configured to:
(I) generate and transmit wildfire alerts to satellite, central, and edge servers; and
(ii) instruct edge servers to initiate autonomous emergency response actions based on wildfire spread prediction models generated by a Wildfire Spread Zone Prediction Engine (WSRZPE).

4. Wherein claim 1, A Central Server System for distributed wildfire monitoring and global response coordination, comprising:
(s) a central server configured to monitor a plurality of distributed wildfire detection nodes and coordinate response operations across regional or global scales;
(t) an integrated AMSFE engine operatively coupled to a wildfire event database and persistent storage subsystem;
(u) a digital twin module representing wildfire-prone regions with historical ignition patterns, fire propagation models, and prior mitigation outcomes;
(v) a data management system configured to process incoming real-time and batch data, extract event-specific features, apply automated dataset labeling, and perform time-series analysis for critical event detection;
(w) an alert distribution system operable to:
(I) issue standardized wildfire alerts via Application Programming Interfaces (APIs);
(ii) deploy AI agents to one or more designated edge servers near the ignition zone; and
(iii) communicate alert data to one or more satellite systems for enhanced situational awareness;
(x) a wildfire event object model including standardized geospatial symbols, GPS coordinates, and estimated impact areas for visualization on global or regional wildfire map platforms; and
(y) an edge processing system operable to:
(i) receive alert data and fuse it with live telemetry from nearby AISNM units; and
(ii) verify ignition events and autonomously trigger localized suppression protocols.

5. Wherein claim 1, A Local Edge Server System for wildfire detection, eradication coordination, and fire status communication, comprising:
(z) an edge server co-located within a drone station or a Firefighting Command and Control Center (FCCC);
(aa) the edge server configured to receive and process data from a plurality of Terrestrial AI Sensing Module Networks (AISNM), with each incoming data stream represented by a dedicated AI agent;
(ab) the edge server further configured to ingest and integrate data from:
(i) local AISNM units;
(ii) satellite servers; and
(iii) a Central Server global wildfire database;
(ac) the Edge Server further configured to access georeferenced historical wildfire event data, digital twin wildfire models, time-series sensor data, fire ignition profiles, local vegetation conditions, land cover classifications, ground topography, and environmental variables including temperature, humidity, and wind;
(ad) the Edge Server using said data to train local AI/ML models and feed a Sensor Fusion Engine (AMSFE), thereby enabling real-time action plans for detection, suppression, and prevention of wildfire ignition, propagation, and spread;
(ae) the Edge Server System further configured to validate high-resolution satellite imagery for mapping of terrain features including transportation routes, topographic elements, lakes, and vegetation;
(af) the Edge Server System confirming integration of GPS-tagged Global or Regional Infrastructure (GTI), comprising drone stations, FCCCs, AISNM nodes, Next-Generation Autonomous Intelligent Communication Network (NGAICN) units, and Auto Wildfire Prevention Rescue Trucks (AWPRT); and
(ag) the integrated datasets being essential components of a Wildfire Spread Risk Zone Prediction Engine (WSRZPE), enabling automatic, precise and rapid deployment of wildfire eradication resources.

6. Wherein claim 1, a system for autonomous dispatch of an AI Inspection Drone (AID) for early wildfire verification, comprising:
(ah) a mission-ready Autonomous Inspection Drone (AID) stationed on a dedicated launch pad within a drone station;
(ai) upon detection of a potential wildfire ignition event, the system configured to automatically dispatch the AID, comprising:
(i) Drone AI Control Modules DACM for autonomous navigation, sensor data management, real-time analysis, and mission automation;
(ii) an Inertial Measurement Unit IMU for stabilization and orientation;
(iii) a GPS-assisted AI navigation system;
(iv) Lidar for 3D imaging and obstacle avoidance;
(v) 2D/3D video imaging systems;
(vi) ember detectors and environmental sensing instruments;
(vii) An onboard Drone AI Control Module DACM governs the drone's communications module NGAICN;
(viii) autonomous flight;
(ix) dynamically determining the optimal flight path to the suspected ignition site;
(x) DACM monitors the on-board devices and sensors;
(xi) The integrated Lidar and imaging systems enable the drone to measure distances, avoid obstacles, and inspect obscured areas beneath forest canopies;
(xii) allowing AID to accurately identify the ignition point; and
(xiii) eradicate within a few feet of the emerging ignition;
(xiii) Once the ignition site is confirmed, the AID transmits its precise geocoordinates along with corresponding visual and sensor data to:
(xiv) the Sensor Fusion Engine hosted on the edge server;
(xv) the associated drone station or Firefighting Command Control Center (FCCC).

7. Wherein claim 1, A system for autonomous wildfire response and post-fire prevention, comprising:
(aj) upon confirmation or high-probability detection of wildfire ignition, the system configured to automatically deploy one or more Autonomous Eradication Drones (AED) from a nearby drone station;
(ak) each AED configured with:
(i) specialized fire suppression payloads comprising water, compressed nitrogen, and other extinguish agents;
(ii) real-time visual and thermal imaging sensors operable under low visibility or nighttime conditions;
(iii) a DACM integrating GPS, IMU, LiDAR, and sensor fusion for fully autonomous flight and suppression operations;
(iv) autonomous discharger for fire payload.
(al) the AED configured to:
(I) autonomously navigate to the ignition site using AI-based pathfinding;
(ii) execute suppression protocols at the ignition site;
(iii) transmit imagery, thermal data, and telemetry to an edge server and FCCC in real-time;
(iv) log all mission data for post-event training and AI model refinement;
(am) a post-suppression verification protocol comprising:
(I) dispatching an AID to the extinguished site for validation;
(ii) close-proximity inspection for residual heat or smoldering signs;
(iii) real-time transmission of validation data to the edge server for site assessment;
(iv) initiating deployment of Autonomous Prevention Drones (APD) if no ignition threats remain;
(an) preventive APD operations comprising:
(i) APDs equipped with retardant dispersal systems deployed to perimeter zones;
(ii) full autonomy in route optimization and terrain-sensitive coverage patterns;
(iii) real-time analysis of vegetation and fire risk conditions via onboard sensors;
(iv) transmission of data to a Wildfire Spread Risk Zone Prediction Engine (WSRZPE) to update risk maps and optimize future fire prevention protocols.

8. Wherein claim 1, a system comprising a Drone Station and a Firefighting Command Control Center (FCCC), the system configured for autonomous wildfire response, wherein:
(ao) the Drone Station is co-located with the FCCC to facilitate coordinated deployment of firefighting drones;
(ap) the FCCC is strategically positioned near a transportation access point selected from the group consisting of highways and major road intersections in proximity to wildfire-prone regions;
(aq) the FCCC comprises operational infrastructure including a Drone Deployment Module (DDM), an AI-Controlled Drone Pad (ACDP), a Drone AI Control Module (DACM), and at least one control interface for mission management;
(ar) each drone is assigned to a designated ACDP and is configured to perform autonomous operations including pre-flight readiness, deployment, and return;
(as) upon receiving a mission command, the DDM initiates automated opening of the Drone Station structure and autonomous drone launch;
(at) following mission completion or resource depletion, each drone autonomously returns to its assigned ACDP and is prepared for subsequent missions; and
(au) the FCCC further includes at least one of an Edge Server, an AI/ML Sensor Fusion Engine, and a Next Generation Autonomous Intelligent Communication Network (NGAICN), wherein the FCCC serves as a command hub for real-time data integration and operational decision-making;
(av) a Central Server may co-locate with the Edge Server and drone station in a FCCC.
(aw) each ACDP supports automated drone recharging, payload loading, and pre-flight testing to enable rapid redeployment;
(ax) the DACM directs the autonomous return and docking of drones following completion of wildfire suppression missions or upon low battery/resource condition;
(ay) the FCCC includes operational components selected from the group consisting of mission control dashboards, graphical user interfaces (GUIs), real-time video monitoring systems, sensor network control panels, dispatch coordination modules, and firefighting coordination tools;
(az) the NGAICN is configured to enable communication between the FCCC and other AISNM units across a multi-node wildfire detection and eradication network;
(ba) the FCCC is operable in a fully autonomous mode without human intervention and further comprises manual override controls to enable human intervention when necessary.

9. A system for rapid ember eradication to prevent wildfire ignition, comprising:
(bb) a plurality of AI Sensor Network Modules (AISNM) and Fire/Ember Extinguishing Modules (FEM), distributed across wildfire-prone regions, each configured to detect and eradicate embers on-site;
(bc) each AISNM comprising an onboard AI Engine (AEOB) and a plurality of miniaturized environmental sensors configured to detect wildfire precursors and combustion products, including embers, smoke, and associated chemical signatures;
(bd) each FEM operatively attached to an AISNM and configured to instantaneously activate and spray extinguishing agents selected from cold dense mist, foam, or other fire-suppressing materials upon detection of embers;
(be) upon detection of an ember, the AISNM configured to issue an alert, transmit a signal to an edge server, and activate all preselected AISNM/FEM units within a designated wildfire risk zone defined by a Wildfire Spread Risk Zone Prediction Engine (WSRZPE);
(bf) the WSRZPE configured to generate and update a geospatial wildfire spread zone surrounding the ignition site;
(bg) an edge server deployment module configured to launch a fleet of autonomous drones, including Autonomous Inspection Drones (AID), Autonomous Eradication Drones (AED), and Autonomous Prevention Drones (APD);
(bh) each AED configured with fire-extinguishing payloads and programmed to autonomously navigate to the ignition site and high-risk zones designated by the WSRZPE;
(bi) each AISNM further configured to initiate local eradication and transmit alerts to the edge server and nearby AISNM units, enabling coordinated and autonomous wildfire prevention;
(bj) post-eradication deployment, AIDs are launched to verify the complete absence of embers, flames, or smoke, after which the system issues a fire-extinguished confirmation;
(bk) launch of APDs to apply fire-retardant materials to the perimeter and surrounding areas of the extinguished zone, operating in fully autonomous mode Independent surrounding areas of the extinguished zone, operating in fully autonomous mode.

10. Wherein claim 9, WSRZPE utilizes time-based AI inference derived from high-speed thermal and video imagery to predict ember spread patterns.

11. Wherein claim 9, the autonomous drones are configured to autonomously return to a drone station for automatic recharging and payload replenishment.

12. Wherein claim 9, drones are further configured to carry and deploy newly charged AISNM units with fully loaded FEM payloads back to the sensor site.

13. Wherein claim 9, alert from one AISNM unit trigger activation of FEMs in neighboring AISNM units to preemptively suppress potential ember or smoke threats.

14. Wherein claim 9, the edge server overlays real-time threat data onto a georeferenced map including infrastructure such as roads, lakes, drone stations, FCCCs, and existing AISNM units.

15. Wherein claim 9, the detection and suppression cycle from precursor identification to eradication action is completed autonomously and rapidly without human intervention.

16. Wherein claim 9, the data communications between AISNM units, drones, and edge servers are coordinated via an AI-managed Next Generation Autonomous Communication network (NGAICN).

17. Wherein claim 9, wherein the WSRZPE determines spread risk zones by simulating ember travel under real-time environmental conditions including wind direction, slope, and vegetation dryness.

18. Wherein claim 9, wherein full eradication is confirmed via feedback from deployed drones, AISNM data, and an AI/ML verification module before issuance of a wildfire extinguishment declaration.

19. Wherein claim 9, wherein the entire process of detection, eradication, and prevention—including sensor inputs, data fusion, warnings, and all generated data—is recorded as a digital twin for use in AI/ML model training and Application Programming Interface (API) updates.

20. An Artificial Intelligence Sensing Network Module (AISNM) comprising:
(bl) a physical enclosure housing an onboard AI processing module (AEOB), an autonomous intelligent network module (AINM), a plural of sensors, battery and a memory module, wherein the enclosure is compact, shoebox-sized or smaller, and configured for mounting on trees, drones, or utility poles;
(bm) a plurality of environmental detection sensors operably connected to the AI module, the sensors comprising at least one of: Lidar, 2D or 3D high-resolution video imaging systems, thermal imaging sensors, particle counters, spectrometers, electromagnetic wave sensors, miniature ion chromatography systems, ion-selective electrodes, atomic absorption spectroscopy (AAS), inductively coupled plasma (ICP) analyzers, mass spectrometers, colorimetry instruments, microelectromechanical system (MEMS) thermal sensors including microbolometers or thermopiles, photoionization detectors (PID), electrochemical gas sensors, air ion counters, UV and IR sensors, and gas-specific sensors;
(bn) the sensors are configured to detect wildfire-indicative parameters including, but not limited to, smoke dispersal, ember movement, elevated ion concentrations, UV and IR radiation, thermal signatures, spectral characteristics of ionized gases, and thermally reactive chemical compounds;
(bo) the AI module configured to perform time-series analysis on real-time sensor data to label anomaly events corresponding to wildfire ignition indicators, including abrupt changes in temperature, particle velocity, ion concentration, or particulate movement;
(bp) the AISNM further configured to stream real-time data related to temperature, humidity, 3D imagery, and ultra-high-resolution particulate analysis including particulate density, direction, material composition, and velocity;
(bq) wherein the onboard AI module is further configured to analyze the visual, thermal, and spectral signature of embers and smoke prior to ground contact, with contextual correlation to weather, temperature, and wind direction;
(br) upon positive identification of wildfire precursors, the AEOB is operable to trigger the Fire Extinguishing Module (FEM), issue alerts, notify adjacent AISNM units and edge servers, and initiate automated suppression protocols;
(bs) upon confirmation that the fire has been extinguished, the AEOB is further configured to transmit a termination signal to adjacent AISNM units and edge servers to revert from active suppression to passive monitoring mode;
(bt) the AISNM unit is engineered to be self-sustaining, comprising an integrated power supply system including a solar panel, battery pack, and maximum power point tracking (MPPT) controller for autonomous off-grid operation;
(bu) the enclosure comprises physical properties including flame resistance, heat insulation, UV and weather protection, electromagnetic shielding, lightweight structural materials, and rugged durability for forest and rural deployment;
(bv) the AISNM unit is communicatively coupled with other AINM units of the Next Generation Autonomous Intelligent Communication Network (NGAICN), and is configured to propagate alerts and activation commands to neighboring modules in regions determined to be at risk of fire propagation;
(bw) the AISNM unit is further configured as a secondary-layer NGAICN node comprising a low-bandwidth LEO satellite communication module AINM and an antenna footprint of 1 square foot or smaller, and wherein said node is operable to extend NGAICN coverage over an additional 20-30 mile radius to support coordination with hundreds or thousands of downstream AISNM/FEM clients;
(bx) Upon validation of an emerging wildfire event by any AEOB within the network, all associated AISNM units and their respective Fire Extinguishing Modules (FEM) are automatically activated to release eradication materials in a coordinated manner, thereby collectively suppressing identified wildfire precursors and extinguishing the emerging fire at once.

21. wherein claim 20, AI/ML Wildfire Spread Risk Zone Prediction Engine (WSRZPE):
(by) is a core AI/ML engine deployed on Central and/or Edge Servers within the multi-layered wildfire prevention architecture;
(bz) is designed to identify and predict high-risk wildfire propagation zones by analyzing real-time and historical data, with a focus on ember dispersal as the primary ignition vector;
(ca) the risky zone is majorly influenced by Ember dispersal and represents a critical factor in wildfire spread dynamics;
(cb) Embers, particularly under high wind conditions, can travel several miles from the original site, landing on flammable surfaces and causing secondary ignitions across vast territories;
(cc) Early identification and modeling of ember movement are essential for anticipating fire spread beyond the immediately visible perimeter;
(cd) High-Speed, High-Resolution AI Imaging is critical for the spread:
(i) The system ingests ultra-high-resolution and high-speed thermal and optical video imaging data from deployed sensing units, including terrestrial AI Sensor Modules (AISNM) and drone-based system;
(ii) Using time-based AI analytics, the system extracts and quantifies key parameters of embers in motion:
(iii) Particle size distribution, Ember density and concentration, Velocity and acceleration, 3D vectorized directional movement over time;
(iv) These image-derived features serve as foundational inputs to WSRZPE.
(ce) Geo-Referenced Risk Zone Mapping:
(cf) Utilizing a GPS-tagged global infrastructure (GGI) and an Earth-based map, the WSRZPE overlays ember movement data to generate predictive risk zone heatmaps;
(cg) These maps identify areas most vulnerable to fire propagation based on the ember trajectory and velocity vectors, considering spatial proximity to combustible vegetation, infrastructure, and terrain characteristics;
(ch) Multi-Factor Predictive Modeling: The WSRZPE integrates a range of pre-trained AI/ML models trained on environmental and topographical datasets, including:
(ci) Elevation profiles (mountains, valleys, hills, slopes), Vegetation type and dryness levels, Presence of lakes, rivers, or firebreaks, Real-time and historical weather data (temperature, humidity, wind speed and direction. Seasonal variations and prior fire events in the area;
(cj) These variables are fused using a sensor fusion engine and advanced AI techniques (e.g., trend detection, changepoint analysis, temporal-spatial modeling) to simulate potential ember routes and predict future spread zones;
(ck) Integration with Response Assets and Eradication Systems: The WSRZPE is integrated with pre-stored GPS-based geolocations of critical wildfire prevention and response assets, including Autonomous Drone Stations, Firefighting Command and Control Centers FCCC, The Terrestrial AI Sensor Module Network AISNM, Next Gen Autonomous Intelligent Communication Network NGAICN, and Autonomous Wildfire Prevention and Rescue Trucks AWPRT;
(cl) Upon detection of a high-risk region, the WSRZPE automatically initiates coordinated emergency operations;
(cm) These include dispatch of drones for targeted ember or flame suppression, activation of ground-based suppressant systems, and notification to FCCCs for broader containment actions;
(cn) Closed-Loop Operational Intelligence
The WSRZPE operates in a fully autonomous mode, allowing for human override but prioritizing rapid, machine-driven responses;
(co) Risk zone predictions are continuously refined in real time based on live sensor inputs and feedback from deployed drones and sensors, the result is a dynamic and continuously updating operational map of wildfire risk, capable of preempting.

22. A Next-Generation Autonomous Intelligent Communication Network (NGAICN) for operation in areas including remote, forested, and previously unreachable Areas, comprising:
(cp) A self-sustaining, layered, and modular intelligent communication and power network that can operate in areas where connections were previously unreachable;
(cq) A distributed satellite receiver operatively coupled to an Autonomous Intelligent network module (AINM) contained in AISM or Drones configured to receive satellite signals through a satellite dish or small devices in rural or historically connection-deprived areas;
(cr) The AINM/AISM module comprises multiband components and software defined Radios that transform the satellite band into commonly used transmission formats, including 5G, 4G LTE, radio and more;
(cs) NGAICN uses Low orbital Leo Satellite as back haul and transmits its signal stream near ground in low band, middle band or high band networks depending on the local environment and end user type and usage;
(ct) NGAICN's end user comprises, cell phone, devices, other AINMs, AISM, servers, gateways, IoT, Wi-Fi modems, and more;
(cu) NGAICN provides end users with routine data communication, internet access, voice, facility, device monitoring, or other usage, including IoT;
(cv) The low band 4G LTE NGAICN communication network )provides coverage in a radius of 15 to 30 miles and is capable of penetrating dense vegetation, including forested areas;
(cw) Each intelligent AINM node service has the capability to cover hundreds or thousands of users or device nodes within a 15-30-mile area;
(cx) Each AINM module is equipped with a satellite dish and device, enabling it to upload and download data packages to and input from other users on the same or different networks;
(cy) The AINM/AISNM is configured to dynamically upgrade to mid-band and high-band frequencies, including 5G/6G, LTE, and Band 14, or any other frequencies upon detection of fires or embers;
(cz) NGAICN's communication policy excludes using high-orbit satellite systems and conventional extremely low data rates such as LoRaWAN and basic radio systems, due to insufficient bandwidth, data rate limitations, and lack of compatibility with 5G and FirstNet emergency protocols;
(da) The NGAICN comprises distributed multilayer dynamic node management:
(i) Layer 1: user or intelligent modules;
(ii) Layer 2: Multiband intelligent communication AINM module layer;
(iii) Layer 3: The regional node layer comprises the network of AINMs in the region;
(iv) Layer 4: The super node layer comprises all the regional nodes in a country;
(v) Layer 5: Comprise all the nodes in the enterprise;
(db) The AISNM may be operated as a second-layer node with a small, low-band Leo satellite dish (1×1 feet or smaller) and an AINM module;
(dc) During an emergency, the AINM/AISNM modules will autonomously switch to provide 5G/6G full-band services, enabling the full radio streaming of ember movement, thermal images, UV/IR visual data, and sensor statistical data, thereby facilitating an efficient autonomous eradication process;
(cd) The NGAICN satellite set up on Drone Station and FCCC comprises a Layer 3 regional layer with wideband, fast 5G/6G services, and is capable of fully communicating with all AISNM modules, central, satellite, and edge servers, providing internet and Voice access;
(de) an FCCC and drone station infrastructure, are equipped with LEO satellite antennas configured to provide high-reliability, high bandwidth internet backhaul, which is then converted into localized terrestrial communication services independent of ground infrastructure;
(df) At the FCCC, the received satellite signal is converted into broadband 5G/6G or 4G LTE, including Band 14, to support the system, server management, and first responders' operations;
(dg) An AI-driven emergency communication upgrade mechanism, wherein an onboard AI engine (AEOB) detects embers, smoke, or thermal anomalies; triggering the immediate transition from routine mode to active emergency mode and initiates FirstNet or equivalent high-speed data channels for real-time video transmission, AI analysis, and command coordination;
(dh) NGAICN is a multilayer, dynamic node management system that enables NGAICN to be used in various countries with different policies and security concerns, making internet connections in previously inaccessible areas;
(di) a renewable power supply system, wherein all communication and sensor units are powered by solar or wind energy, managed by maximum power point tracking (MPPT) controllers achieving greater than 95% power efficiency.

26. Wherein claim 22, a redundancy and failover mechanism, wherein mobile rescue vehicles or airborne drones equipped with satellite communication dishes are configured to function as temporary FCCC or AISNM replacements in the event of emergency or infrastructure damage.

27. Wherein claim 22, a wireless charging interface for drones, wherein drones are capable of wirelessly transferring energy to AISNM modules through electromagnetic induction, with or without physical contact, is instrumental in low-sunlight environments.
